(19) United States
(12) Patent Application Publication
(10) Pub. No.: US 2013/0194204 A1
(43) Pub. Date: Aug. 1, 2013

(54) DISPLAY DEVICE INTEGRATED WITH TOUCH SCREEN PANEL

(71) Applicants: Sung-Ku KANG, Yongin-City (KR); Hak-Sun Kim, Yongin-City (KR); Tae-Hyeog Jung, Yongin-City (KR); Sun-Haeng Cho, Yongin-City (KR)

(72) Inventors: Sung-Ku KANG, Yongin-City (KR); Hak-Sun Kim, Yongin-City (KR); Tae-Hyeog Jung, Yongin-City (KR); Sun-Haeng Cho, Yongin-City (KR)

(21) Appl. No.: 13/477,227

(22) Filed: May 22, 2012

(30) Foreign Application Priority Data
Jan. 26, 2012 (KR) 10-2012-0007943

(51) Int. Cl. G06F 3/041

(52) U.S. Cl. 345/173

(57) ABSTRACT

A display device integrated with a touch screen panel includes top and bottom substrates, each being divided into a display region, a first region on an outline of the display region, and a second region on an outline of the first region, pixels in the display region of the bottom substrate, pads in the second region of the bottom substrate, signal lines in the first region of the bottom substrate electrically coupling the pixels to the pads, sensing patterns in the display region of the top substrate, sensing lines in the first region of the top substrate and coupled to the sensing patterns, an auxiliary display unit in the first region of the top substrate that overlaps the sensing lines, and a window on a top surface of the top substrate that includes a decoration layer overlapping only a second region of the top substrate.

### CROSS-REFERENCE TO RELATED APPLICATION

This application claims priority to and the benefit of Korean Patent Application No. 10-2012-0007943, filed on Jan. 26, 2012, in the Korean Intellectual Property Office, the entire content of which is incorporated herein by reference.

### BACKGROUND

1. Field

Example embodiments relate to a display device, and more particularly, to a display device integrated with a touch screen panel.

2. Description of the Related Art

A touch screen panel is an input device capable of selecting the indicated content displayed on the screen of an image display device by a human hand or an object as input of a command of a user. As such, the touch screen panel is provided on the entire surface of the image display device to convert a contact position of the human hand or the object into an electrical signal, and the instruction contact selected in the contact position is received as an input signal. Since the touch screen panel may replace an additional input device coupled to the image display device to operate, e.g., a keyboard and a mouse, the use range of the touch screen panel is gradually increasing.

Methods of realizing a touch screen panel include, e.g., a resistance layer method, a photo-sensing method, and a capacitance method. For example, the touch screen panel by the capacitance method senses a change in capacitance formed by a conductive sense pattern together with another peripheral sense pattern or a ground electrode when the human hand or the object contacts the touch screen panel to convert the contact position into an electrical signal.

The touch screen panel may be manufactured to be attached to an external surface of the display panel of a flat panel display (FPD), e.g., a liquid crystal display (LCD) and an organic light emitting display. A window may further be provided on a top surface of the touch screen panel in order to improve the strength of an apparatus.

### SUMMARY

Example embodiments have been made to provide a display device integrated with a touch screen panel directly on an organic light emitting display panel, so a window is attached to the touch screen panel and an auxiliary display unit adjacent a display region displays a predetermined image. A decoration layer formed on the frame of the window does not overlap the auxiliary display region adjacent to the display region of the touch screen panel, so that it is possible to maximize a region on which an image is displayed.

In order to achieve the foregoing and/or other aspects of the example embodiments, there is provided a display device integrated with a touch screen panel, including a top substrate and a bottom substrate, each of the top and bottom substrates being divided into a display region, a first region on an outline of the display region, and a second region on an outline of the first region, a plurality of first pixels in the display region of the bottom substrate, a plurality of pads in the second region of the bottom substrate, a plurality of signal lines in the first region of the bottom substrate electrically coupling the plurality of first pixels to the plurality of pads, respectively, a plurality of sensing patterns in the display region of the top substrate, a plurality of sensing lines in the first region of the top substrate and coupled to the sensing patterns, respectively, an auxiliary display unit in the first region of the top substrate, the auxiliary display unit overlapping the sensing lines, and a window on a top surface of the top substrate, the window including a decoration layer overlapping only a second region of the top substrate.

Each of the first pixels in the display region of the bottom substrate may include an organic light emitting diode (OLED), thin film transistors (TFT), and a capacitor, the first pixels are being configured to be driven in a top emission method.

The auxiliary display unit in the first region of the top substrate may include a plurality of second pixels, the second pixels including OLEDs and are driven in a bottom emission method.

The display device may further include a bonding pad unit with a plurality of bonding pads in the second region of the top substrate, the bonding pads being coupled to the sensing lines.

The display device may further include a sealing material contacting the second region in each of the top and bottom substrates, the top and bottom substrates being attached to each other via the sealing material.

The sensing patterns may include first sensing cells adjacent to each other along a first direction, first coupling lines coupling adjacent first sensing cells in the first direction, second sensing cells adjacent to each other along a second direction, and second coupling lines coupling adjacent second sensing cells in the second direction.

The first and second sensing cells may be in a same plane.

The sensing patterns and the sensing lines may be on an internal surface of the top substrate, the internal surface of the top substrate facing the bottom substrate.

The display device may further include an insulating layer between the auxiliary display unit and the sensing lines.

The sensing patterns and the sensing lines may be on an external surface of the top substrate, the external surface of the top substrate facing away from the bottom substrate.

The auxiliary display unit may be on an internal surface of the top substrate, the internal surface of the top substrate facing the bottom substrate.

The top substrate may be a thin film having a laminated structure of a plurality of organic and inorganic layers.

The laminated structure of the thin film may include an alternating arrangement of organic and inorganic layers.

Each of the bottom substrate and the window may include a flexible material.

The flexible material may be a polyimide based resin.

The display regions of the top and bottom substrates may be aligned and completely overlap each other, the auxiliary display unit extending beyond the display region of the bottom substrate to surround the display region of the top substrate.

A total area of the display region on the top substrate and the auxiliary display unit may be larger than a total area of the display region on the bottom substrate.

Pixels in the auxiliary display unit and pixels in the display region of the bottom substrate may face different directions.

### BRIEF DESCRIPTION OF THE DRAWINGS

The accompanying drawings, together with the specification, illustrate exemplary embodiments of the example embodiments, and, together with the description, serve to explain the principles of the example embodiments.

FIG. 1 is a divided plan view illustrating the top substrate, the bottom substrate, and the window of a display device according to an embodiment;

FIG. 2 is an enlarged view of a sensing pattern illustrated in FIG. 1;

FIG. 3 is a cross-sectional view of a display device according to an embodiment of FIG. 1;

FIG. 4 is a cross-sectional view of a display device according to another embodiment; and

FIG. 5 is a cross-sectional view of a display device according to still another embodiment.

### DETAILED DESCRIPTION

Korean Patent Application No. 10-2012-0007950, filed on Jan. 26, 2012, in the Korean Intellectual Property Office, and entitled: “Organic Light Emitting Display Device and Driving Method Thereof' is incorporated by reference herein in its entirety.

Hereinafter, embodiments will be described in detail with reference to the accompanying drawings.

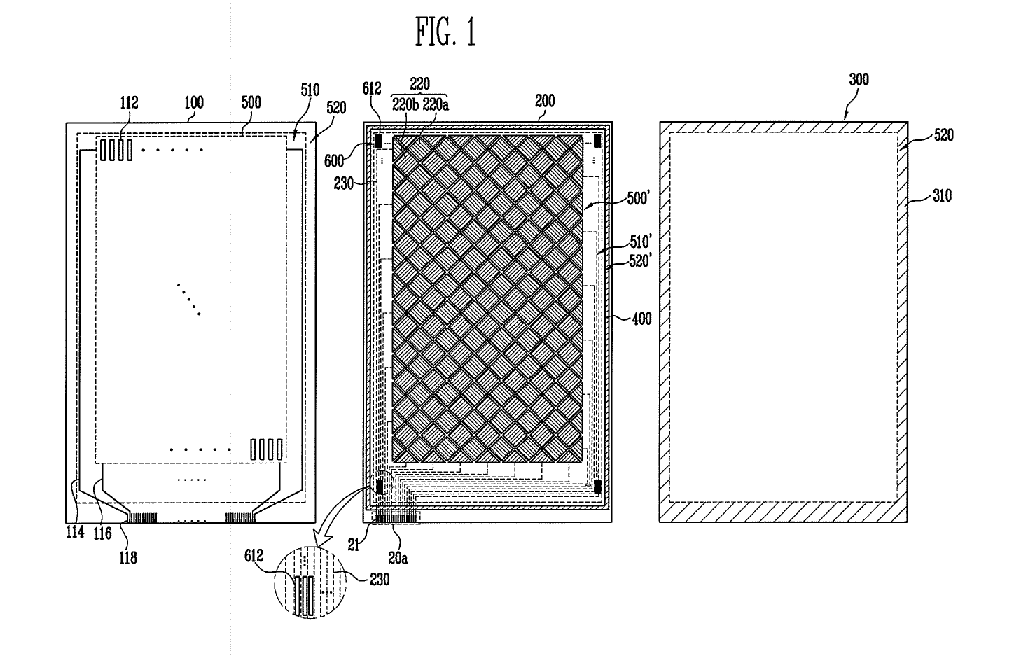

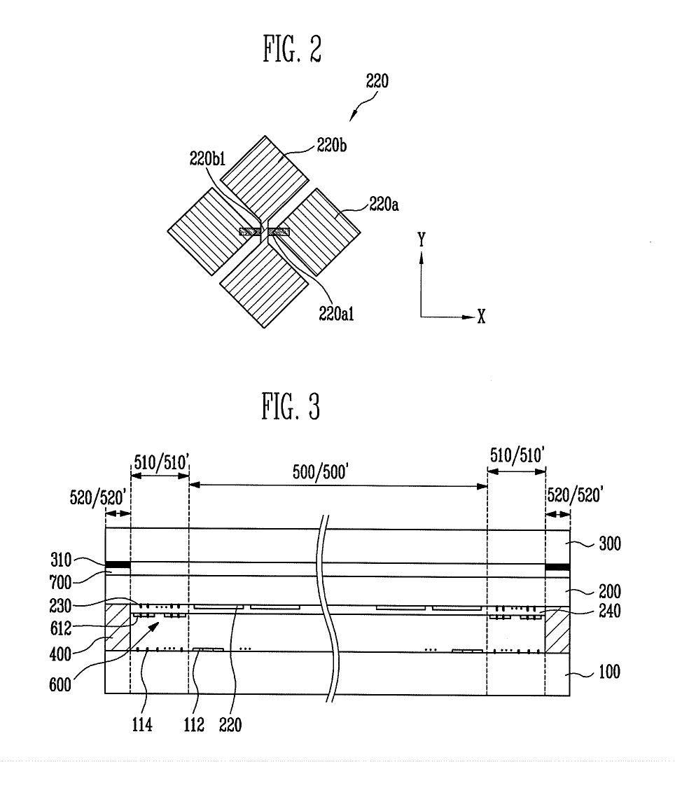

FIG. 1 is a divided plan view of the top substrate, the bottom substrate, and the window of a display device according to an embodiment, FIG. 2 is an enlarged view of the sensing pattern illustrated in FIG. 1, and FIG. 3 is a cross-sectional view of a display device according to an embodiment of FIG. 1.

Referring to FIGS. 1 to 3, a display device integrated with a touch screen panel according to an embodiment includes sensing patterns 220 and sensing lines 230 on an internal surface of a top substrate 200, a plurality of pixels 112 formed in a display region 500 of a bottom substrate 100, a window 300, and a decoration layer 310 on a frame of the window 300. The bottom substrate 100 and the top substrate 200 are attached to each other to seal the pixels 112 therebetween and to constitute an organic light emitting display panel. The window 300 is on the top substrate 200.

An organic light emitting diode (OLED) (not shown), thin film transistors (TFTs) (not shown), and a capacitor (not shown) are provided in each of the pixels 112 formed in the display region 500 of the bottom substrate 100. The pixels 112 are driven in a top emission method. That is, the image generated by the pixels 112 is transmitted to the top substrate 200 to be displayed to a user.

In detail, the display device integrated with the touch screen panel according to an embodiment includes the display panel including the bottom substrate 100 and the top substrate 200 that face each other and the touch screen panel including the sensing patterns 220 and the sensing lines 230 on the internal, i.e., rear, surface of the top substrate 200 that faces the bottom substrate 100.

In order to realize the display panel, the bottom substrate 100 is divided into the display region 500, in which the plurality of pixels 112 are formed, and a non-display region provided along the outline, i.e., periphery, of the display region 500. The display region 500 of the bottom substrate 100 overlaps a display region 500′ of the top substrate 200. The non-display region of the bottom substrate 100 overlaps an auxiliary display region 510′ and a non-display region 520′ of the top substrate 200. In addition, the non-display region of the bottom substrate 100 is divided into a first region 510, in which signal lines 114 and 116 are formed, and a second region 520 coated with a sealing material 400 for sealing with the top substrate 200. For example, the top and bottom substrate 200 and 100 are assembled so regions 500 and 500′ are aligned and completely overlap each other, regions 510 and 510′ are aligned and completely overlap each other, and regions 520 and 520′ are aligned and completely overlap each other.

As illustrated in FIG. 1, pads 118 coupled to the signal lines 114 and 116 are further formed at a lower end of the second region 520.

In the embodiment illustrated in FIG. 1, the top substrate 200, e.g., an encapsulating substrate of the organic light emitting display panel, is preferably realized by a glass substrate. As illustrated in FIG. 3, the window 300 is attached to a top surface of the top substrate 200 by a transparent adhesive layer 700, e.g., an optical clear adhesive (OCA), in order to improve strength of the apparatus.

As further illustrated in FIG. 3, the decoration layer 310 is formed, e.g., only, in a region that overlaps the non-display region 520′ of the top substrate 200, as the frame region of the window 300. As such, the auxiliary display region 510′ of the top substrate 200, i.e., a region between the display region 500′ and the non-display region 520′ of the top substrate 200, may remain exposed.

In contrast, in a conventional device, a decoration layer may be formed to overlap an entire region outside a display region of a top substrate. However, in the example embodiment, the decoration layer 310 does not overlap the auxiliary display region 510′ of the top substrate 200, so the decoration layer 310 has a small width.

The touch screen panel according to the embodiment includes the sensing patterns 220 formed on the rear surface of the top substrate 200, i.e., on an internal surface of the transparent encapsulating substrate. The touch screen panel according to the embodiment also includes the sensing lines 230 for coupling the sensing patterns 220 to an external driving circuit (not shown) through a bonding pad unit 20a, as illustrated in FIG. 1. The plurality of sensing patterns 220 are formed in the display region 500′ on which an image is displayed to detect a touch position. The sensing lines 230, electrically coupled to the sensing patterns 220, and the region in which the bonding pad unit 20a is formed are provided on the outline of the display region 500′.

In addition, in the embodiment, an auxiliary display unit 600 to display a predetermined image is provided. The auxiliary display unit 600 overlaps, e.g., completely overlaps, the auxiliary display region 510′ in which the sensing lines 230 are formed. That is, referring to FIG. 3, the auxiliary display unit 600 is formed on an insulating layer 240 with which the sensing lines 230 are covered. In other words, the sensing lines 230, the insulating layer 240, and the auxiliary display unit 600 are formed sequentially on the internal surface of the top substrate 200, such that the auxiliary display unit 600 faces the bottom substrate 100. The insulating layer 240 separates, e.g., completely separates, the sensing lines 230 from the auxiliary display unit 600. It is noted that the auxiliary display unit 600 and the sensing lines 230 are formed only in the auxiliary display region 510′ of the top substrate 200.

The auxiliary display unit 600 includes a plurality of pixels 612. An OLED (not shown), TFTs (not shown), and a capacitor (not shown) may be provided in each of the pixels 612. The pixels 612 are driven by a bottom emission method, so an image generated by the pixels 612 is transmitted to the bottom substrate 100 to be displayed to the user. As such, the image is displayed in a direction directed away from the sensing lines 230, so the sensing lines do not interfere with the image displayed by the auxiliary display unit 600.

The pixels 612 included in the auxiliary display unit 600 may be realized in a passive matrix, unlike the pixels 112 in an active matrix formed on the display region 500 of the bottom substrate 100. It is noted that in the example embodiments, the additional auxiliary display unit 600 in the region 510′ displays images, despite the sensing lines 230, thereby maximizing a display region that may be recognized by the user. In contrast, in a conventional display device, a region including the sensing lines is a non-display region overlapping a decoration layer on a frame of a window, thereby having a substantially smaller display region.

In addition, the pixels 612 included in the auxiliary display unit 600 are formed in a region that does not intersects the sensing lines 230 that overlap the auxiliary display unit 600, so it is possible to prevent the sensing lines 230 from being recognized. That is, as illustrated in FIGS. 1 and 3, the sensing lines 230 are arranged in positions corresponding to regions between the pixels 612, e.g., each sensing line 230 is positioned to overlap a region between two adjacent pixels 612, so that the pixels 612 on which a predetermined image is displayed do not intersect the sensing lines 230.

In addition, it is possible to prevent the signal lines 114 and 116 formed in the first region 510 of the bottom substrate 100 that overlaps the auxiliary display unit 600 from being recognized due to the auxiliary display unit 600. Various applications, e.g., icons that supplement a screen other than the main screen displayed on the display region 500, may be displayed by the auxiliary display unit 600.

The second region, i.e., the non-display region 520′ of the top substrate 200, is formed on an outline, e.g., on a peripheral region external to and extending along a boundary of, the first region, i.e., the auxiliary display region 510′. The bonding pad unit 20a including a plurality of bonding pads 21 coupled to the sensing lines 230 is formed on the non-display region 520′. The non-display region 520′ is coated with a sealing material 400 in order to have the top substrate 200 and the bottom substrate 100 adhered to each other. The sealing material 400 is coated only on regions 520 and 520′, and laser is radiated through the region 520 to harden the sealing material 400 and to have the top substrate 200 and the bottom substrate 100 adhered to each other.

As described above, the non-display region 520′ overlaps the decoration layer 310 formed on the window 300, so that it is possible to prevent the bonding pads 21 from being recognized by the user. In other words, as the decoration layer 310 of the window 300 overlaps only the regions 520 and 520′, i.e., portions of the top and bottom substrate 100 and 200 already covered by the sealing material 400, so any wires formed in regions 520 and 520′, e.g., the pads 21, will not be recognized by the user.

Referring to FIGS. 1 and 2, the structure of the touch screen panel according to the embodiment will be described in detail as follows.

As illustrated in FIG. 2, the sensing patterns 220 include a plurality of first sensing cells 220a formed to be coupled by row lines in a first direction (X axis direction), first coupling lines 220a1 for coupling the first sensing cells 220a in the first direction, second sensing cells 220b formed to be coupled by column lines in a second direction (Y axis direction), and second coupling lines 220b 1 for coupling the second sensing cells 220b in the second direction.

The first sensing cells 220a and the second sensing cells 220b are alternately arranged not to overlap each other. The first coupling lines 220a1 and the second coupling lines 220b1 intersect each other. An insulating layer (not shown) for securing stability is interposed between the first coupling lines 220a1 and the second coupling lines 220b1.

The first sensing cells 220a and the second sensing cells 220b may be formed to be integrated with or separated from the first coupling lines 220a1 and the second coupling lines 220b1 using a transparent electrode material, e.g., indium tin oxide (ITO), to be electrically coupled to the first coupling lines 220a1 and the second coupling lines 220b1. For example, the second sensing cells 220b are patterned to be integrated with the second coupling lines 220b 1 in the second direction, and the first sensing cells 220a are patterned between the second sensing cells 220b to have independent patterns and to be coupled to each other by the first coupling lines 220a1 positioned on or under the first sensing cells 220a.

The first coupling lines 220a1 may directly contact the first sensing cells 220a on or under the first sensing cells 220a to be electrically coupled to the first sensing cells 220a or may be electrically coupled to the sensing cells 220a through contact holes. The first coupling lines 220a1 may be formed of a transparent electrode material, e.g., ITO, or may be formed of an opaque low resistance material so that the width thereof is controlled to prevent the patterns from being visible.

The sensing lines 230 are electrically coupled to the first and second sensing cells 220a and 220b in units of row and column lines to couple the first and second sensing cells 220a and 220b to an external driving circuit (not shown), e.g., a position detecting circuit, through the bonding pad unit 20a. The sensing lines 230 are arranged in the auxiliary display region 510′, e.g., along an outline of the display region 500′ on which an image is displayed. The sensing lines 230 may be formed of any suitable material, e.g., a low resistance material or a transparent electrode material used for forming the sensing patterns 220. Examples of suitable low resistance materials may include Mo, Ag, Ti, Cu, Al, and Mo/Al/Mo.

When a contact object, e.g., a human hand or a stylus pen, contacts the touch panel described above in a capacitance method, e.g., when the contact objects contacts a region on the display region 500′ of the top substrate 200, a change in capacitance in accordance with the contact position is transmitted from the sensing patterns 220 to a driving circuit (not shown) via the sensing lines 230 and the bonding pad unit 20a. Then, the change in the capacitance is converted into an electrical signal by an X and Y input processing circuit (not shown) to grasp the contact position.

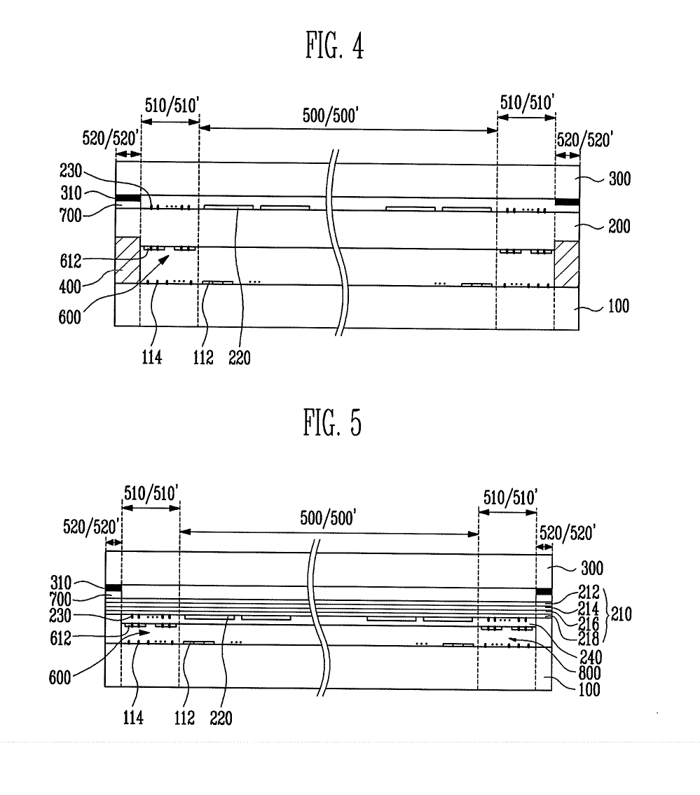

FIG. 4 is a cross-sectional view of a display device according to another embodiment. The embodiment in FIG. 4 is substantially the same as the embodiment described previously with reference to FIGS. 1 to 3, with the exception of having the elements of the touch screen panel, i.e., the sensing patterns 220 and the sensing lines 230, on the external surface of the top substrate 200, as opposed to the internal surface of the top substrate 200. Therefore, detailed description of elements described previously with reference to FIGS. 1 to 3 will be omitted.

In the embodiment of FIG. 4, the sensing lines 230 and the auxiliary display unit 600 are formed on difference surfaces of the top substrate 200, i.e., on opposite surfaces of the top substrate 200. Therefore, an insulating layer 240 on the internal surface of the top substrate 200 may be removed.

FIG. 5 is a cross-sectional view of a display device according to another embodiment. The embodiment in FIG. 5 is substantially the same as the embodiment described previously with reference to FIGS. 1 to 3, with the exception of having an encapsulating thin film 210, instead of the top substrate 200. Therefore, detailed description of elements described previously with reference to FIGS. 1 to 3 will be omitted.

Referring to FIG. 5, the encapsulating thin film 210 is formed in order to protect the OLED provided in each of the pixels 112 of the bottom substrate 100, and may be realized in a laminated structure of a plurality of organic and inorganic layers. The encapsulating thin film 210 may be formed to have, for example, a structure in which a first organic layer 212, a first inorganic layer 214, a second organic layer 216, and a second inorganic layer 218 are alternately laminated in order to effectively block oxygen and moisture that may penetrate the encapsulating thin film 210 from the outside.

In addition, the first and second organic layers 212 and 216 of the encapsulating thin film 210 prevent or substantially minimize nano and micro cracks in the first and second inorganic layers 214 and 218. As such, the penetration path of the oxygen and moisture, as well as water vapor transmission rate and stress in the first and second inorganic layers 214 and 218, may be reduced. The first and second organic layers 212 and 216 may be formed of, e.g., at least one of epoxy, acrylate, and urethaneacrylate. The first and second inorganic layers 214 and 218 may be formed of, e.g., at least one of AlₓO_{y} and SiₓO_{y}.

As further illustrate in FIG. 5, the touch screen panel and the auxiliary display unit 600 are formed on the internal or external surface of the encapsulating thin film 210, on which the touch screen panel and the auxiliary display unit 600 are formed. The encapsulating thin film 210 is laminated on the bottom substrate 100 using a transparent adhesive layer 800, e.g., the adhesive layer 800 may have a lower width than the sealing material 400. That is, in the embodiment of FIG. 5, the sealing material 400 may be removed, so the region of the auxiliary display unit 600 may be realized to be wider.

In addition, although the encapsulating thin film 210 is realized in a laminated structure of four layers, a total thickness of the encapsulating thin film 210, i.e., a total thickness of the four laminated layers, may be smaller than that of the top substrate 200. As such, it is possible to realize a flexible display device. That is, when the bottom substrate 100 and the window 300 are realized by a material having a flexible property, e.g., a polyimide based resin, the entire display panel may be flexible.

According to the example embodiments, an organic light emitting display panel may include an auxiliary display unit adjacent to a display region of a touch screen panel to display a predetermined image through the auxiliary display region, so a region on which the image is displayed is maximized and the decoration layer formed on the frame of the window does not overlap the auxiliary display region. In addition, a top of an organic light emitting display panel, i.e., an encapsulating substrate or an encapsulating thin film, is used as the substrate of the touch screen panel, so a thickness of a FPD integrated with the touch screen panel is minimized to reduce a number of substrates and to improve transmittance.

In contrast, a conventional display device with a touch screen panel that includes a decoration layer, e.g., a black frame, surrounding a display region in order to prevent visibility of a wiring line in the non-display area may have a limited structure. That is, when a size of a screen is maximized, i.e., when a region on which an image is displayed is maximized, the screen may not be extended to the region that overlaps the decoration layer, as the decoration layer is formed in the non-display region adjacent to the display region, thereby limiting the design of the screen

While the example embodiments has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display device integrated with a touch screen panel, comprising:
a top substrate and a bottom substrate, each of the top and bottom substrates being divided into a display region, a first region on an outline of the display region, and a second region on an outline of the first region;
a plurality of first pixels in the display region of the bottom substrate;
a plurality of pads in the second region of the bottom substrate, a plurality of signal lines in the first region of the bottom substrate electrically coupling the plurality of first pixels to the plurality of pads, respectively;
a plurality of sensing patterns in the display region of the top substrate;
a plurality of sensing lines in the first region of the top substrate and coupled to the sensing patterns, respectively;
an auxiliary display unit in the first region of the top substrate, the auxiliary display unit overlapping the sensing lines; and
a window on a top surface of the top substrate, the window including a decoration layer overlapping only a second region of the top substrate.

2. The display device as claimed in claim 1, wherein each of the first pixels in the display region of the bottom substrate includes an organic light emitting diode (OLED), thin film transistors (TFT), and a capacitor, the first pixels are being configured to be driven in a top emission method.

3. The display device as claimed in claim 2, wherein the auxiliary display unit in the first region of the top substrate includes a plurality of second pixels, the second pixels including OLEDs and are driven in a bottom emission method.

4. The display device as claimed in claim 1, further comprising a bonding pad unit with a plurality of bonding pads in the second region of the top substrate, the bonding pads being coupled to the sensing lines.

5. The display device integrated as claimed in claim 1, further comprising a sealing material contacting the second region in each of the top and bottom substrates, the top and bottom substrates being attached to each other via the sealing material.

6. The display device as claimed in claim 1, wherein the sensing patterns include:
first sensing cells adjacent to each other along a first direction;
first coupling lines coupling adjacent first sensing cells in the first direction;
second sensing cells adjacent to each other along a second direction; and
second coupling lines coupling adjacent second sensing cells in the second direction.

7. The display device as claimed in claim 6, wherein the first and second sensing cells are in a same plane.

8. The display device as claimed in claim 1, wherein the sensing patterns and the sensing lines are on an internal surface of the top substrate, the internal surface of the top substrate facing the bottom substrate.

9. The display device as claimed in claim 8, further comprising an insulating layer between the auxiliary display unit and the sensing lines.

10. The display device as claimed in claim 1, wherein the sensing patterns and the sensing lines are on an external surface of the top substrate, the external surface of the top substrate facing away from the bottom substrate.

11. The display device as claimed in claim 10, wherein the auxiliary display unit is on an internal surface of the top substrate, the internal surface of the top substrate facing the bottom substrate.

12. The display device as claimed in claim 1, wherein the top substrate is a thin film having a laminated structure of a plurality of organic and inorganic layers.

13. The display device as claimed in claim 12, wherein the laminated structure of the thin film includes an alternating arrangement of organic and inorganic layers.

14. The display device as claimed in claim 12, wherein each of the bottom substrate and the window includes a flexible material.

15. The display device as claimed in claim 14, wherein the flexible material is a polyimide based resin.

16. The display device as claimed in claim 1, wherein the display regions of the top and bottom substrates are aligned and completely overlap each other, the auxiliary display unit extending beyond the display region of the bottom substrate to surround the display region of the top substrate.

17. The display device as claimed in claim 1, wherein a total area of the display region on the top substrate and the auxiliary display unit is larger than a total area of the display region on the bottom substrate.

18. The display device as claimed in claim 1, wherein pixels in the auxiliary display unit and pixels in the display region of the bottom substrate face different directions.
